(19) United States
(12) Patent Application Publication
(10) Pub. No.: US 2008/0281455 A1
(43) Pub. Date: Nov. 13, 2008

(54) Materials, Operations and Tooling Interface and Methods for Managing a Remote Production Facility

(76) Inventor: Kenneth Swegman, Alpharetta, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/747,484

(22) Filed: May 11, 2007

(51) Int. Cl. G06F 19/00

(52) U.S. Cl. 700/107; 700/105

(57) ABSTRACT

A system and method for managing a remote manufacturing facility are described. The system includes a network, data store, interface, and a processor. The interface is located at a manufacturing facility. The processor and data store are located at a location removed from the manufacturing facility. The network communicatively couples the interface to the data store and the processor. The data store includes information that directs technicians through the steps associated with manufacturing sub-assemblies and assemblies. The information includes bill-of-materials, manufacturing instructions, partially completed quality assurance documents, part identifiers and part parameters, tool identifiers and tool parameters, as well as annotations and images.

### BACKGROUND

Computer-based tools have become indispensable to managing the complexity entailed in designing and manufacturing many modern products. Engines and the automobiles, ships, planes, trucks, equipment, tools, etc. that use them are examples of such complex products.

One aspect of the complexity involved in the design and manufacture of an engine is the number and variability of constituent sub-assemblies and component parts. Generally, an engine is assembled from a catalogue of sub-assemblies and component parts according to a particular set of design specifications. Because of the number and variability of parts, it can be difficult for manufacturers to ensure that technicians have assembled a particular engine correctly. A correct final assembly will include all designated sub-assemblies and component parts assembled in the desired sequence with all the desired fasteners, locking compounds, lubricants, and other materials in accordance with one or more desired manufacturing specifications.

Traditional approaches used in instructing assembly technicians are based on a document-centric model of information exchange. Various documents are generated via the computer-based tools and communicated within and across organizations on their way to the technicians who assemble the products. These traditional approaches introduce communication inefficiencies in organizations with multi-disciplinary teams and where complex products are being manufactured by remotely-located technicians that may or may not be within the same organization as those writing the assembly instructions. Once a product (e.g., an engine) design has stabilized, inefficiencies also arise from searching for and updating each copy of the documents containing product information. Technicians often end up with instructions and other documentation absent any information whatsoever as to whether their particular copy is up to date. In addition, many engine and other complex assemblies require that one or more quality assurance logs or records be generated in parallel with the manufacture of each unit produced. Accordingly, a substantial amount of information must be generated, communicated and maintained via a document-centric model of information exchange.

Despite the development of computer-based tools for managing the complexity entailed in designing and manufacturing many modern products further improvements are desired, especially in the development of systems and methods that make advantageous use of available data networks.

### SUMMARY

Systems and methods for remotely managing the materials, operations and tools used in manufacturing complex assemblies are illustrated and described.

One embodiment of a system for guiding technicians through manufacturing tasks includes a network, a data store, a first interface and a processor. The data store, first interface and processor are communicatively coupled to one another via the network. The first interface is located at a manufacturing site. The processor is configured to enable a user of the interface to controllably access information in the data store. The information includes at least a bill-of-materials, manufacturing instructions, partially completed quality assurance documents, part identifiers and parameters, tool identifiers and parameters among other possible items.

In an alternative embodiment, the system is configured with a management interface that provides edit capabilities to all items in the data store to those with manager-level privileges. A select set of items are accessible and editable by users with technician-level privileges.

Another embodiment describes a method for managing a remote production facility. The method comprises the steps of providing instructions for manufacturing assemblies and sub-assemblies, providing information responsive to parts, tools and operations referenced in the instructions for manufacturing each of the assemblies and sub-assemblies, providing a set of quality assurance documents referenced in the instructions for manufacturing each of the assemblies and sub-assemblies and controllably granting access to a network-coupled interface that exposes the instructions, information related to the parts and tools, as well as information in the quality assurance documents.

Other systems, methods, features and advantages will be or will become apparent to one with skill in the art upon examination of the following figures and detailed description. All such additional systems, methods, features and advantages are defined and protected by the accompanying claims.

### BRIEF DESCRIPTION OF THE DRAWINGS

The present systems and methods for managing a remote production facility, as defined in the claims, can be better understood with reference to the following drawings. The components within the drawings are not necessarily to scale relative to each other; emphasis instead is placed upon clearly illustrating the principles for managing a remote production facility.

FIG. 1 is a functional block diagram illustrating an embodiment of a distributed manufacturing environment.

FIG. 2 is a functional block diagram of the data store of FIG. 1.

FIG. 3 is a functional block diagram of the remote (i.e., mechanic/inspector) interface device of FIG. 1.

FIG. 4 is a functional block diagram of the management interface device of FIG. 1.

FIG. 5 is a flow diagram illustrating an embodiment of a method for managing a remote production facility.

FIG. 6 is a flow diagram illustrating an alternative embodiment of a method for managing a remote production facility.

FIGS. 7A-7F are schematic diagrams illustrating various graphical-user interfaces generated for presentation on the remote interface device of FIG. 3.

FIGS. 8A-8D are schematic diagrams illustrating example embodiments of quality assurance documents.

FIGS. 9A and 9B are schematic diagrams illustrating example embodiments of a change-request form and a summary of change-request information, respectively.

### DETAILED DESCRIPTION

Systems and methods for instructing technicians and quality assurance inspectors through the process of manufacturing an assembly from sub-assemblies and their component parts will be explained in detail with regard to the illustrated embodiments. In general, it should be understood that while the detailed description below is focused on the actions of a manager in providing information regarding materials, operations, tooling, etc. to remotely located technicians and inspectors, the technician (i.e., remote) interface and data store provide a convenient mechanism for technicians and inspectors to record and thus centrally store information regarding the manufacture of each assembly.

A manager or managing organization develops and stores assembly instructions and a set of quality assurance documents for each particular item to be assembled at a remote manufacturing facility. The instructions and quality assurance documents are associated with each assembly and saved in the data store. The manager further arranges information regarding sub-assemblies that will be used to manufacture the completed assembly or final product. The information includes sub-assembly identifiers, production sequences, component-part identifiers, quantities and descriptions as well as tool identifiers, descriptors, etc. and operations that are to be performed using the above to manufacture and record the process of manufacturing the assembled product. Operations include a combination of written text, photographs showing various parts, sub-assemblies and tools and relationships between the same. Photographs are annotated to further identify various items, relationships, etc. including fasteners, adhesives, and anti-seize compounds used in a particular operation. In some cases, multiple photographs are presented to convey physical relationships between component parts, partially completed sub-assemblies, tools and the like at various stages or steps in the described operation. In other cases, audio and video information can be selected for presentation.

The provided information is controllably accessed and navigable via a remote interface. The remote interface exposes the above-described information to technicians, inspectors and others with appropriate access privileges. Technicians, inspectors, and other interested parties can be co-located with the managing entity or at a manufacturing plant or other location remote from the managing entity. The remote interface is a graphical-user interface that includes a plurality of controls responsive to operator inputs. The remote interface may include any number of input/output devices such as a keyboard, a pointing device, a microphone, a video recorder, a single-image camera, etc.

The various technicians and inspectors involved with the manufacture and quality assurance functions associated with a particular engine build interact with instructions, specifications, part and tool information, as well as partially completed quality assurance documents that are completed during various build operations and inspections to construct an electronic record of each engine. In some embodiments, technicians, inspectors or other interested parties augment the quality assurance record by using the remote interface to record images and verbal notes.

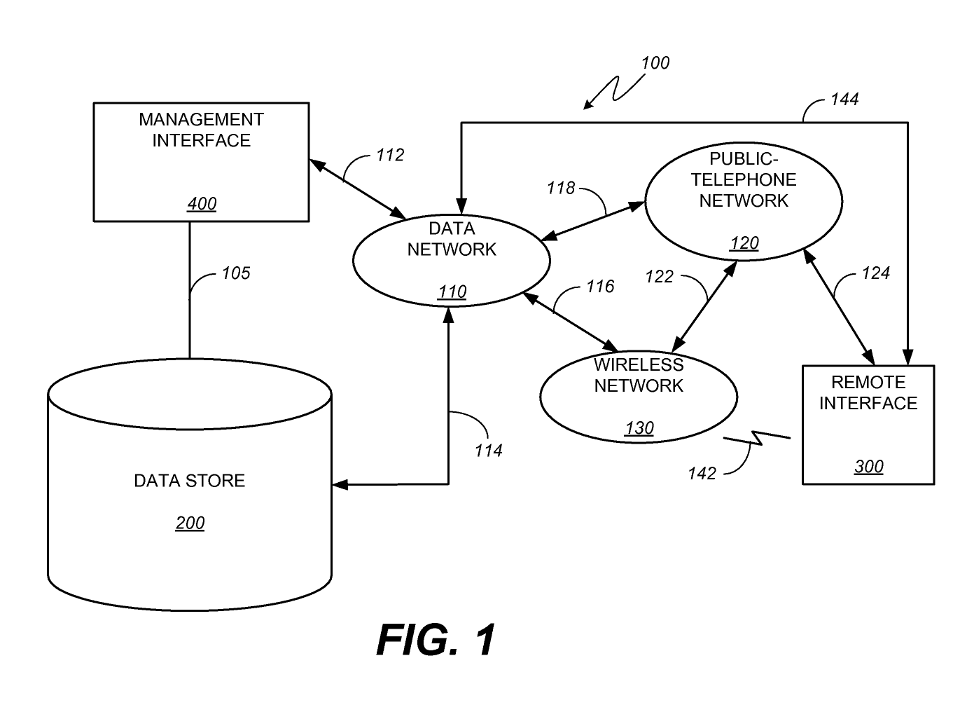

Having generally described the operation of the systems and methods for managing a remote production facility, various additional embodiments will be described with respect to FIGS. 1-9B. FIG. 1 is a functional block diagram illustrating an embodiment of a distributed manufacturing environment. Distributed manufacturing environment 100 includes one or more networks such as data network 110, public-telephone network 120 and wireless network 130 one or more of which communicatively couple management interface 400 and data store 200 to remote interface 300. Data store 200 is coupled to data network 110 via link 114. Data store 200 includes appropriately configured memory locations that information used in the manufacturing environment.

Management interface 400 is coupled to data network 110 via link 112 and to data store 200 via link 105. Management interface 400 is further coupled to data store 200 via link 112, data network 110, and link 114. Management interface 400 is configured to operate or direct the operation of one or more programs that enable a user to populate or otherwise configure data store 200 and selectively grant access to information within data store 200 to one or more operators via remote interface 300. Management interface 400 includes both input and output devices configured to bi-directionally transfer information between the operator, temporary storage elements within management interface 400 and data store 200.

Data network 110 is coupled to public-telephone network 120 via link 118. Data network 110 is further coupled to wireless network 130 via link 116 and to remote interface 300 via link 144. Wireless network 130 is coupled to public-telephone network 120 via link 122. Public-telephone network 120 is coupled to remote interface via link 124. Wireless network 130 is coupled to remote interface 300 via radio-frequency link 142.

Data network 110 is a wide-area network that distributes information to and from coupled devices using indirect packet-based communication protocols such as transmission-control protocol/Internet protocol (TCP/IP). Public-telephone network 120 is a wide-area network that distributes information to and from coupled devices using a combination of technologies including digital portions, analog portions and portions that include both with digital transmissions occurring over a first range of frequencies and analog transmissions occurring over a second range of frequencies. Wireless network 130 can be a local-area network supported by a wireless router and perhaps one or more wireless access points configured to forward data transmissions to and from remote interface 300. Alternatively, wireless network 130 can be a wide-area network such as a cellular network that supports a general-packet radio service.

Link 112, link 114, link 116, link 118, link 122, link 124 and link 144 may be wired or wireless (e.g., infrared or radio-frequency communication links). Link 142 is a wireless communication link. The connectivity provided by the combination of data network 110, public-telephone network 120, wireless network 130 and the various links provides multiple alternative pathways for bi-directional data transfers between data store 200 and remote interface 300. In alternative embodiments, data store 200, remote interface 300 and management interface 400 may be communicatively coupled via a local-area network, a publicly accessible wide-area network such as the Internet, a virtual private network, a proprietary or private network or combinations of these networks.

Remote interface 300 is configured to operate or direct the operation of one or more programs that enable a user to interact with information held in data store 200. Remote interface 300 includes both input and output devices configured to bi-directionally transfer information between its operator(s), temporary storage elements within remote interface 300 and data store 200.

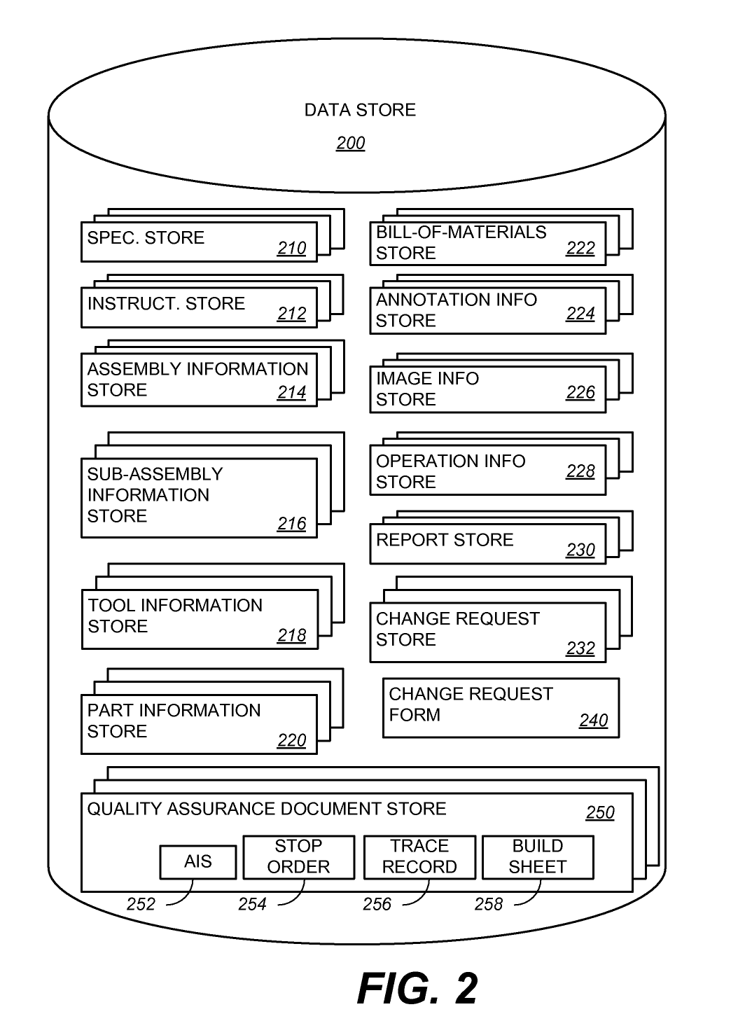

FIG. 2 is a functional block diagram of the data store 200 of FIG. 1. Data store 200 includes a host of items provided via management interface 400. Some of these items (e.g., manufacturing specifications) are authored by third parties and will not be modified. These items are presented for reference only. Other items, such as instructions, assembly information, sub-assembly information, part information, tool information, bills-of-material lists, operations, etc. will be generated, stored and edited by an operator of the management interface with appropriate authority to perform these functions. Still other items, such as quality assurance documents and a change-request form are generated and stored by an operator of the management interface. The quality assurance documents and change request form are partially complete and provided to an operator of remote interface 300 to complete at a desired time. Data store 200 also includes storage locations that hold items such as reports that reflect information extracted or otherwise derived from other locations.

As illustrated in FIG. 2, data store 200 may include one or more instances of manufacturing specifications in specification store 210. Manufacturing specifications include detailed information regarding standards for materials, procedures, fasteners and the like to ensure final assemblies are functional and somewhat uniform across separate units.

Instruction store 212 holds one or more instances of manufacturing instructions. Manufacturing instructions include instructions for constructing one or more assemblies from its constituent sub-assemblies, as well as instructions for constructing one or more sub-assemblies from their constituent component parts.

Assembly information store 214 holds one or more instances of assembly information. Assembly information includes data associated with a particular assembly (e.g., identifiers, sub-assemblies, parts and tools).

Sub-assembly information store 216 holds one or more instances of sub-assembly information. Sub-assembly information includes data associated with a particular sub-assembly (e.g., identifiers, assemblies where the sub-assembly is used, parts, tools).

Tool information store 218 holds one or more instances of tool information. Tool information includes data associated with a particular tool (e.g., identifiers, assemblies and sub-assemblies where the tool is used).

Part information store 220 holds one or more instances of part information. Part information includes data associated with a particular part (e.g., identifiers, assemblies and sub-assemblies where the part is used).

Bill-of-materials store 222 includes one or more instances of bill-of-materials information. Bill-of-materials information includes identifiers, descriptors and quantities of each component used to manufacture a sub-assembly or an assembly.

Annotation information store 224 holds one or more annotations. Annotations include text-based or audio notes that augment a figure and or images of assemblies, sub-assemblies, parts, tools and combinations thereof.

Image information store 226 holds one or more instances of image information. Image information includes digital information arranged in a standardized format for storing photographs and/or videos.

Operation information store 228 includes one or more instances of operation information. Operation information includes data that describes how a mechanic or technician should perform a series of actions to complete a task.

Report store 230 holds one or more instances of report information. Report information includes information that has been extracted or otherwise derived from relationships or object dependencies between each of the aforementioned data abstractions. Generally, report information is generated in response to one or more inputs entered by an operator of the management interface 400 or the remote interface 300. Alternatively, one or more programs operable on either management interface 400 or remote interface 300 may be configured to generate a request for a select report. Request generation can be responsive to an external stimulus such as when a particular order is complete, inspected, shipped, etc.

Change request store 232 holds one or more instances of a change request. A change request includes information regarding an identified problem with any of the previously described data abstractions. For example, an instruction describing the manufacture of an assembly may include a step that lists an incorrectly sized fastener. Change request information will include information about an affected item, the technician or inspector that initiated the request and in some cases a proposed solution. Change request form 240 includes a set of labels and data entry locations for collecting the above-described information to initiate or open a change request.

Quality assurance document store 250 includes one or more sets of partially completed forms such as assembly instruction sheet (AIS) 252, stop order 254, trace record 256 and build sheet 258. In operation, a technician or inspector using remote interface 300 retrieves information representing one or more of the quality assurance documents. As particular steps are completed, sub-assemblies are inspected and approved, etc. information is added to data store 200 to complete each quality assurance document.

The above-described instances of data abstractions can be associated and defined in a relational database configured to organize and expose the data stored therein via one or more procedure programming languages, which have routines, subroutines, and/or functions. Alternatively, the above-described data abstractions can be defined and organized via one or more object-oriented databases that organize and expose the data stored therein using programming languages, which have classes of data and methods.

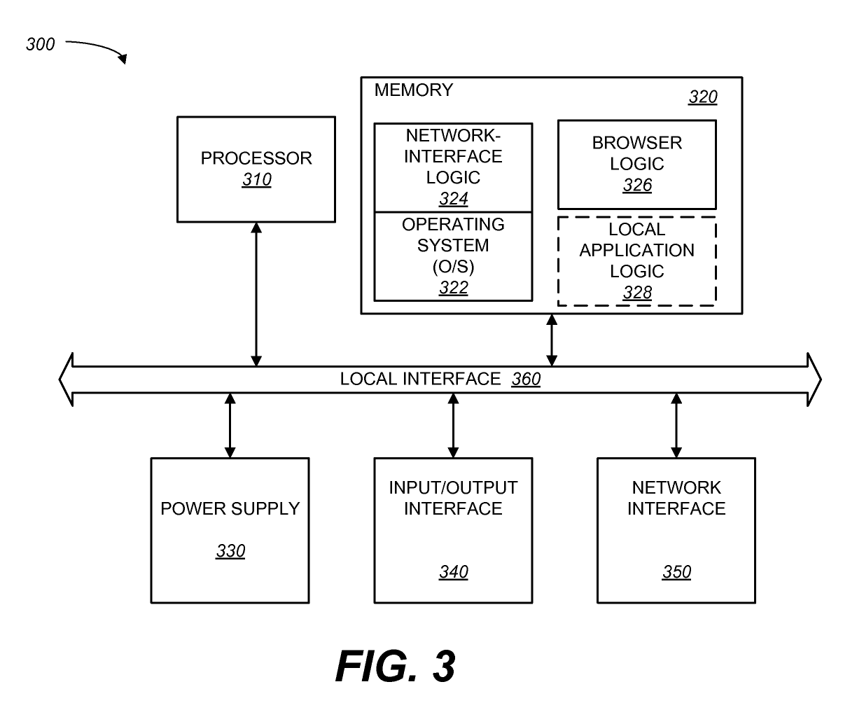

FIG. 3 is a functional block diagram of the remote interface 300 of FIG. 1. Generally, in terms of hardware architecture, as shown in FIG. 3, remote interface 300 includes processor 310, memory 320, power supply 330, input/output (I/O) interface 340 and network interface 350. Processor 310, memory 320, power supply 330, I/O interface 340 and network interface 350 are communicatively coupled via local interface 360. The local interface 360 can be, for example but not limited to, one or more buses or other wired or wireless connections, as is known in the art. The local interface 360 may have additional elements, which are omitted for simplicity, such as controllers, buffers (caches), drivers, repeaters, and receivers, to enable communications. Further, the local interface 360 may include address, control, power and/or data connections to enable appropriate communications among the aforementioned components.

Power supply 330 provides power to each of the processor 310, memory 320, I/O interface 340, network interface 350 and local interface 360 in a manner understood by one of ordinary skill in the art.

Processor 310 is a hardware device for executing software, particularly that stored in memory 320. The processor 310 can be any custom made or commercially available processor, a central processing unit (CPU), an auxiliary processor among several processors associated with the remote interface 300, a semiconductor based microprocessor (in the form of a microchip or chip set), or generally any device for executing software instructions.

The memory 320 can include any one or combination of volatile memory elements (e.g., random-access memory (RAM), such as dynamic random-access memory (DRAM), static random-access memory (SRAM), synchronous dynamic random-access memory (SDRAM), etc.) and nonvolatile memory elements (e.g., read-only memory (ROM), hard drive, tape, compact disk read-only memory (CD-ROM), etc.). Moreover, the memory 320 may incorporate electronic, magnetic, optical, and/or other types of storage media. Note that the memory 320 can have a distributed architecture, where various components are situated remote from one another, but can be accessed by the processor 310.

The software in memory 320 may include one or more separate programs, each of which comprises an ordered listing of executable instructions for implementing logical functions. In the example of FIG. 3, the software in the memory 320 includes operating system 322, network-interface logic 324, browser logic 326 and optional local application logic 328. The operating system 322 essentially controls the execution of other computer programs, such as network-interface logic 324, browser logic 326 and local application logic 328 and provides scheduling, input-output control, file and data management, memory management, communication control and related services.

Network-interface logic 324 comprises one or more programs and one or more data elements that enable the remote interface 300 to communicate with external devices via network interface 350. In this regard, network-interface logic 324 may include one or buffers and parameter stores for holding configuration information and or data as may be required.

Browser logic 326 comprises one or more programs and one or more data elements that enable the remote interface 300 to communicate with external devices including data store 200 via hypertext mark-up language pages or frames communicated via network interface 350. In this regard, browser logic 326 may include one or buffers and parameter stores for holding configuration information and or data as may be required. In addition, browser logic 326 may include one or more add-on programs including toolbars, extensions, helper objects, etc. to expose image, audio, and video information.

Local application logic 328 comprises one or more programs and one or more data elements that enable the remote interface 300 to generate, store and communicate text, image, audio and video information with external devices including data store 200 via network interface 350. In this regard, local application logic 328 may include one or buffers and parameter stores for holding configuration information and or data as may be required.

Network-interface logic 324, browser logic 326 and local application logic 328 are source programs, executable programs (object code), scripts, or other entities that include a set of instructions to be performed. When implemented as source programs, the programs are translated via a compiler, assembler, interpreter, or the like, which may or may not be included within memory 320, to operate properly in connection with the O/S 322.

I/O interface 340 includes multiple mechanisms configured to transmit and receive information via remote interface 300. These mechanisms include serial, parallel, analog and digital video data protocols and the like. I/O interface 340 can be configured to use any device configured to receive and transmit audio, video, text, symbols and other information. Accordingly, remote interface 300 can be integrated with a microphone, a camera, a video camera, a keyboard, a display and a human-to-machine interface associated with a personal digital assistant or other portable communication devices. Such human-to-machine interfaces may include touch sensitive displays or the combination of a graphical-user interface and a controllable pointing device such as a mouse.

Network interface 350 enables remote interface 300 to communicate with various network devices, including for example, an IP-PBX over public-telephone network 120 (FIG. 1), an IP-PBX over data network 110 (FIG. 1) and a wireless router over wireless network 130. Network interface 350 performs a variety of functions including, for example: answering a phone line; hanging-up a phone line; dialing a phone number; sending data signals; receiving data signals; generating DTMF tones; detecting DTMF tones; receiving ANI and DNIS, playing voice messages; and converting voice signals between analog and digital formats. Network interface 350 performs the signal conditioning and format conversions to communicate data through each of data network 110, public-telephone network 120 and wireless network 130 as desired. Preferably, network interface 350 is compatible with the 100BaseT Ethernet standard and the TCP/IP protocol. It should be understood that other data-network interfaces compatible with other hardware and software standards and protocols may also be used.

When remote interface 300 is in operation, the processor 310 is configured to execute software stored within the memory 320, to communicate data to and from the memory 320, and to generally control operations of the remote interface 300 pursuant to the software. The network-interface logic 324, browser logic 326, local application logic 328 and the O/S 322, in whole or in part, but typically the latter, are read by the processor 310, perhaps buffered within the processor 310, and then executed.

When the network-interface logic 324, browser logic 326 and local application logic 328 are implemented in software, as is shown in FIG. 3, it should be noted that these software elements can be stored on any computer-readable medium for use by or in connection with any computer related system or method. In the context of this document, a “computer-readable medium” can be any means that can store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a RAM (electronic), a ROM (electronic), an erasable programmable read-only memory (EPROM), an electrically erasable programmable read-only memory (EEPROM), or Flash memory) (electronic), an optical fiber (optical), and a CDROM (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where one or more of the network-interface logic 324, browser logic 326 and local application logic 328 are implemented in hardware, the network-interface logic 324, browser logic 326 and local application logic 328 can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field-programmable gate array (FPGA), etc.

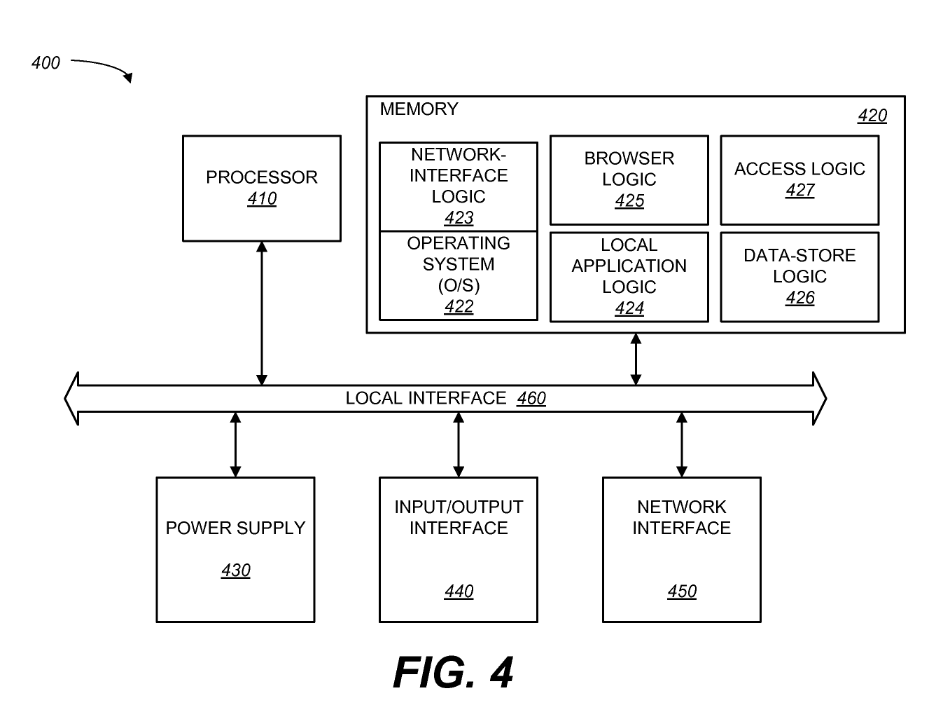

FIG. 4 is a functional block diagram of the management interface 400 of FIG. 1. Management interface 400 includes processor 410, memory 420, power supply 430, input/output (I/O) interface 440 and network interface 450. Processor 410, memory 420, power supply 430, I/O interface 440 and network interface 450 are communicatively coupled via local interface 460 and generally configured similarly to the respective devices described above in association with remote interface 300. Accordingly, a detailed explanation of each is not repeated.

The software in memory 420 includes additional programs or collections of logic that are not provided in the illustrated and described embodiment of remote interface 300 (FIG. 3). For example, memory 420 further includes data-store logic 426 and access logic 427. Data-store logic 426 includes configuration items, structured rules, as well as software to update and query one or more structured sets of persistent data, such as the persistent data in data store 200. Access logic 427 includes configuration items, structured rules as well as software to update usernames and data access/edit privileges for administrators, managers, technicians, and inspectors. Administrators have access and edit privileges to all information other than third-party provided specifications in the distributed manufacturing environment 100. Managers have access and edit privileges to instructions, operations, assembly and sub-assembly information, part and tool information and other information used to instruct those technicians and inspectors who will be actually manufacturing assemblies. Technicians and inspectors have access privileges to view specifications, instructions, operations, assembly and sub-assembly information, part and tool information and other information in data store 200. Technicians and inspectors have access and edit privileges to quality assurance document store 250 and change request form 240.

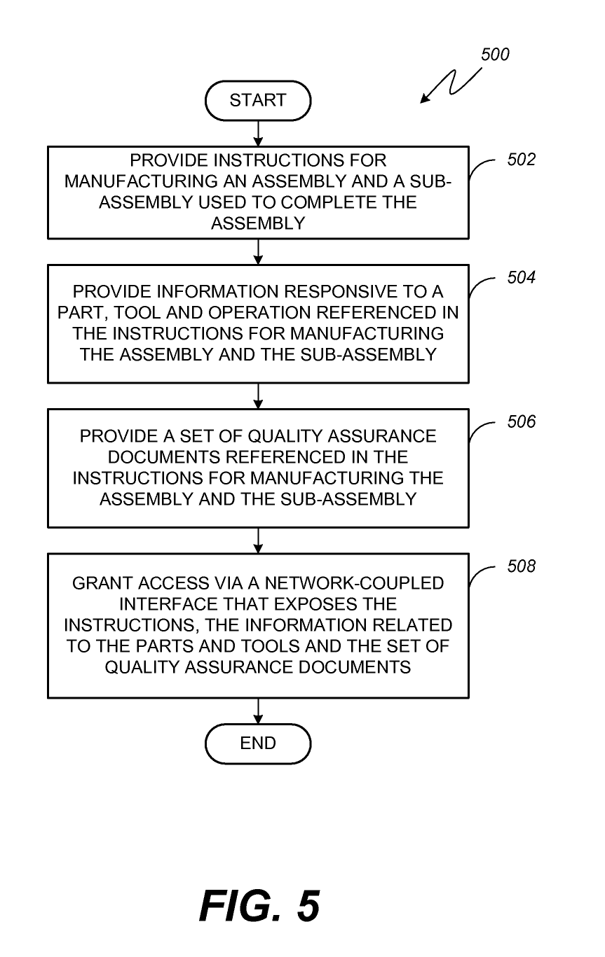

FIG. 5 is a flow diagram illustrating an embodiment of a method for managing a remote production facility. The flow diagram of FIG. 5 shows the architecture, functionality, and operation of a possible implementation via software and or firmware associated with communicatively coupled interface devices that enable a manager to direct the actions of technicians and inspectors at a remote production facility. In this regard, each block represents a module, segment, or portion of code, which comprises one or more executable instructions for implementing the specified function(s).

Method 500 begins with block 502 where a manager provides instructions for manufacturing an assembly and a sub-assembly. As indicated in block 504, the manager further provides information regarding a part, tool and an operation referenced in the instructions. As shown in block 506, the manager also provides a set of quality assurance documents to be used by those assembling and inspecting the assembly and sub-assembly. Thereafter, as shown in block 508, the manager grants access via a network-coupled interface (e.g., remote interface device 300) to expose the instructions, information and the set of quality assurance documents to those granted access privileges.

When operable, those with access privileges can view instructions stored in a remote data store via a network-coupled interface device located proximal to the location where one or more assemblies will be manufactured. In addition to manufacturing instructions, those with access privileges can observe a host of reference and support materials including specifications, information about sub-assemblies, component parts, tools and the like. Moreover, those with access privileges can observe and enter information into a set of quality assurance documents stored in the data store. In most embodiments, the quality assurance documents are configured with at least some entries that correspond to information that can be determined and applied to the form without necessitating an operator input. Other information can be entered using the remote interface device 300 and used to complete quality assurance documents at appropriate times during the manufacturing process.

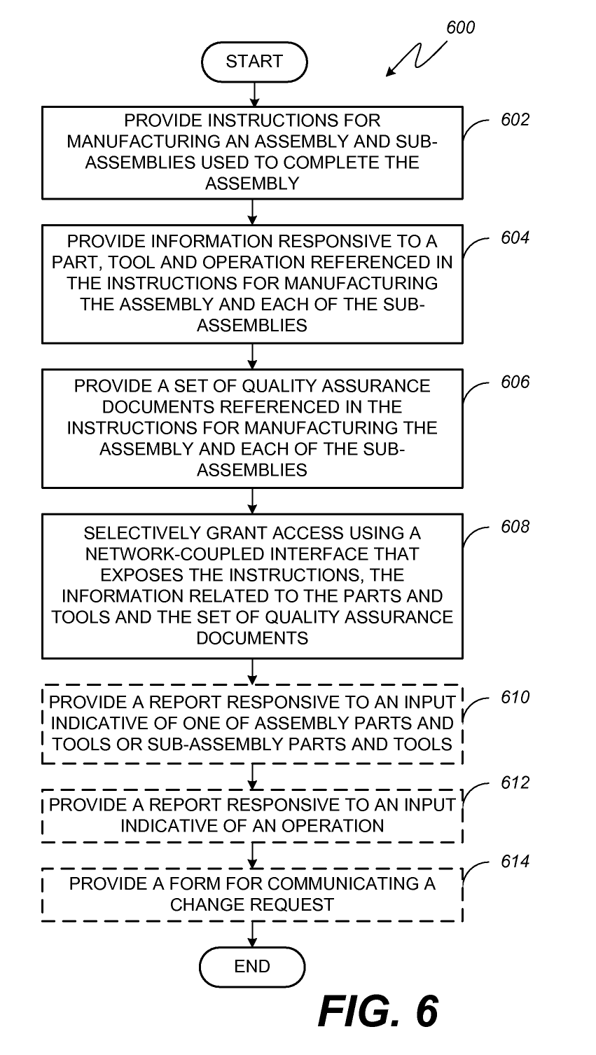

FIG. 6 is a flow diagram illustrating an alternative embodiment of a method for managing a remote production facility. The flow diagram of FIG. 6 shows the architecture, functionality, and operation of a possible implementation via software and or firmware associated with communicatively coupled interface devices that enable a manager to direct the actions of technicians and inspectors at a remote production facility. In this regard, each block represents a module, segment, or portion of code, which comprises one or more executable instructions for implementing the specified function(s).

Method 600 begins with block 602 where a manager provides instructions for manufacturing an assembly and sub-assemblies used in completing the assembly. Both assemblies and sub-assemblies can be manufactured from instructions that describe the procedural integration of their respective component parts. As indicated in block 604, the manager further provides information concerning a part. Tool and operation referenced in the instructions. As shown in block 606, the manager also provides a set of quality assurance documents to be used by those manufacturing and inspecting the assembly and each of the sub-assemblies. Thereafter, as shown in block 608, the manager selectively grants access using a network-coupled interface (e.g., remote interface device 300) to expose the instructions, information and the set of quality assurance documents to those granted access privileges.

The flow diagram in FIG. 6 further reveals optional reports, searches and requests provided by a manager. For example, in optional block 610 a manager provides logic configured to interface with the data store to provide a report in response to a user input that identifies a user interest of one of the assembly parts and tools or sub-assembly parts and tools. In optional block 612, a manager provides logic configured to interface with the data store to provide a report in response to a user input that identifies a user interest in a particular operation. In optional block 614, a manager provides logic configured to interface with the data store to provide a form that can be completed by a user interested in communicating a change request to the manager or some other party having change authority.

When operable, those with access privileges can not only receive information as illustrated and described above with regard to the flow diagram of FIG. 5, but those with access privileges can direct the generation of one or more reports regarding a specific assembly or sub-assembly level part and assembly or sub-assembly level tool. In addition, those with access privileges can direct the generation of one or more reports concerning specified operations. Moreover, those with access privileges can direct the retrieval of a form for communicating a change request.

As described above, the flow diagrams of FIGS. 5 and 6 show the architecture, functionality and operation of an implementation of example methods for managing remote manufacturing operations and quality assurance record production. The described functions can be embodied in source code including human-readable statements written in a programming language or machine code that comprises instructions recognizable by a suitable execution system such as a processor in a computer system. The machine code may be converted from the source code, etc. If embodied in hardware, each block may represent a circuit or a number of interconnected circuits to implement the specified logical function(s).

While the flow diagrams of FIGS. 5 and 6 show specific sequences of execution, it will be appreciated that the functions associated with two or more blocks in the illustrated diagrams that are shown occurring in succession may be executed concurrently or with partial concurrence. In addition, any number of counters, state variables, warning semaphores, or messages might be added to the logical flow described herein, for purposes of enhanced utility, accounting, performance measurement, troubleshooting, etc. All such variations are within the scope of the present systems and methods for managing a manufacturing facility.

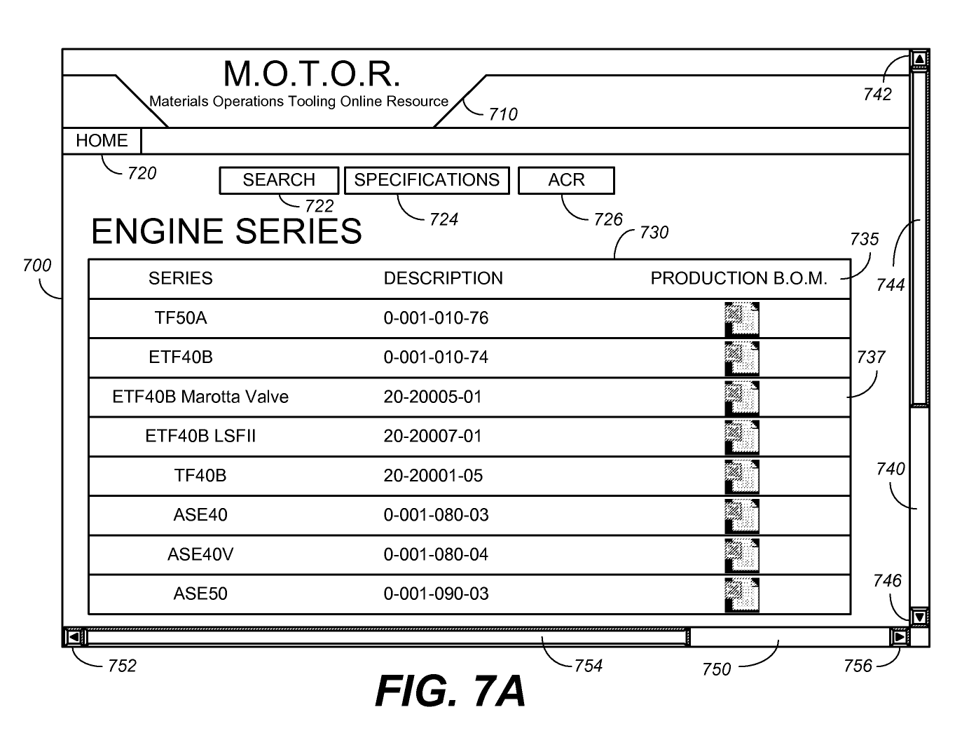

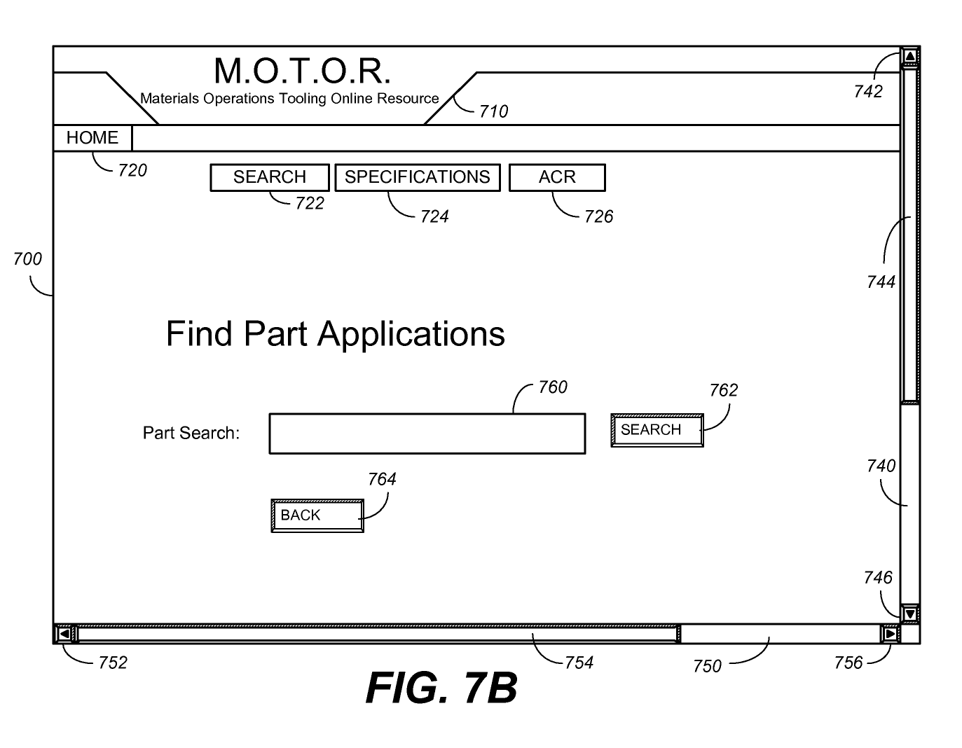

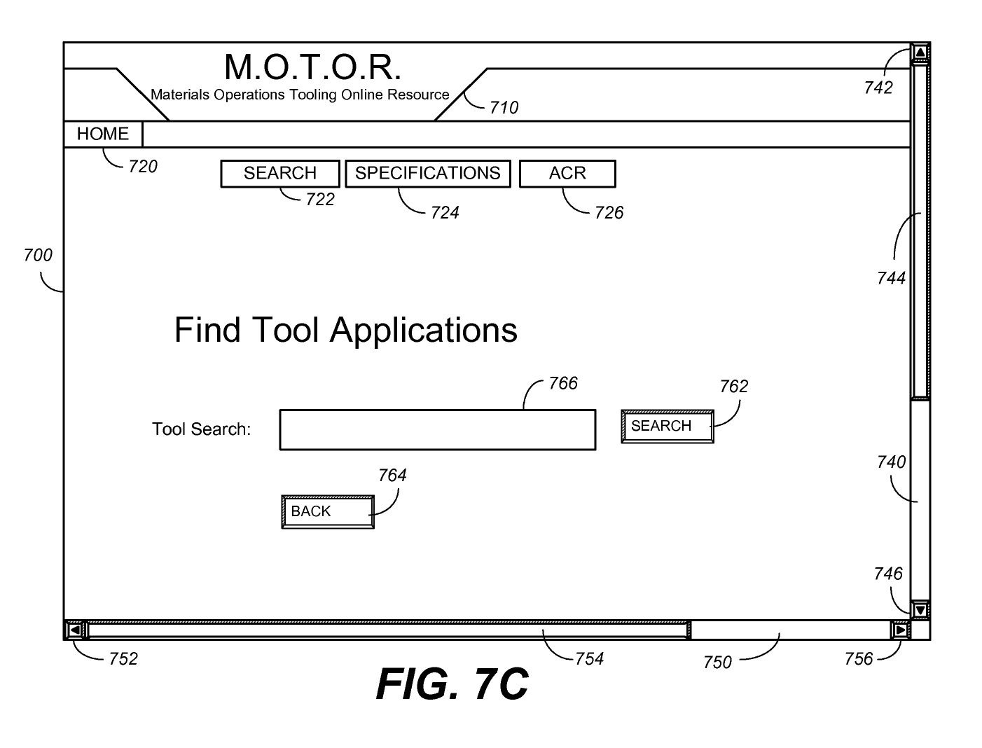

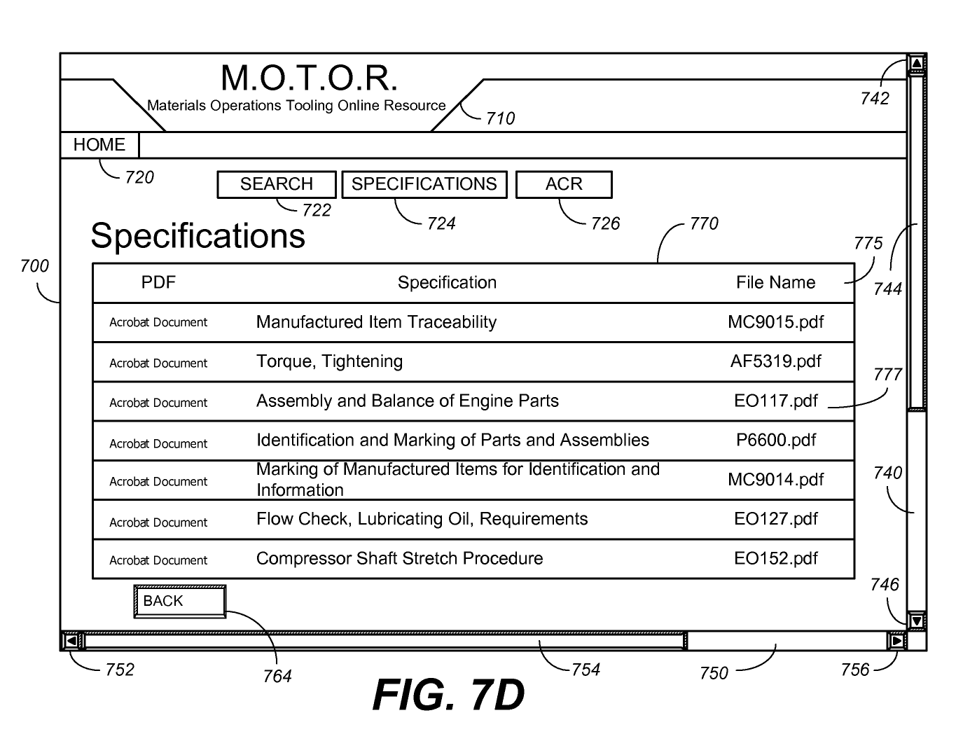

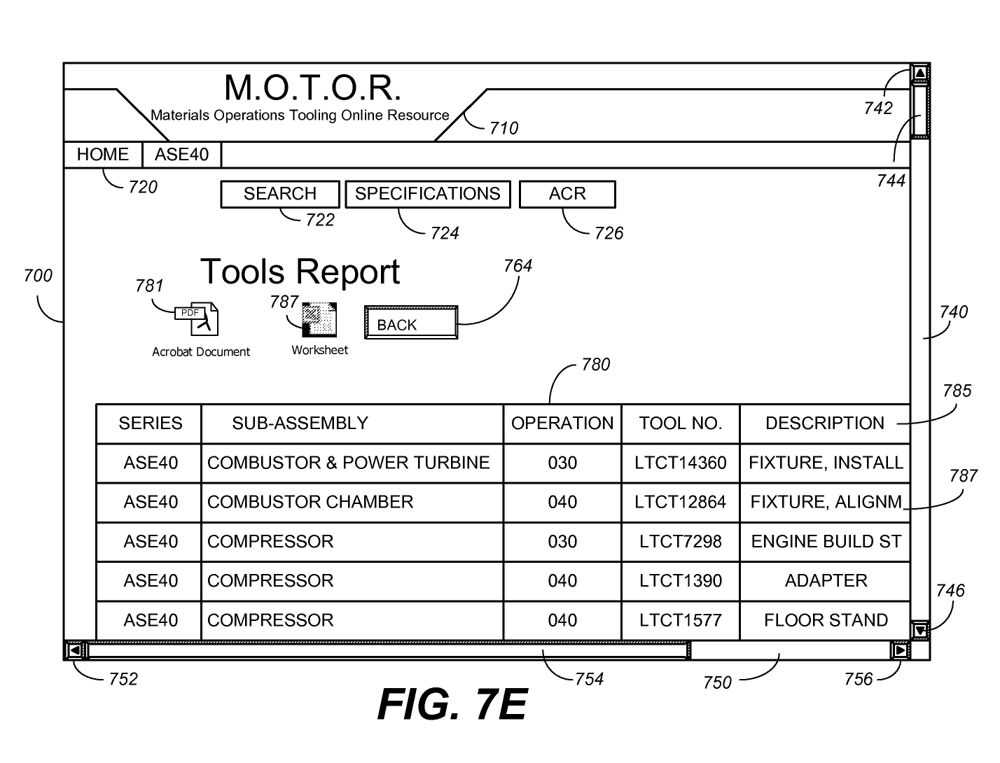

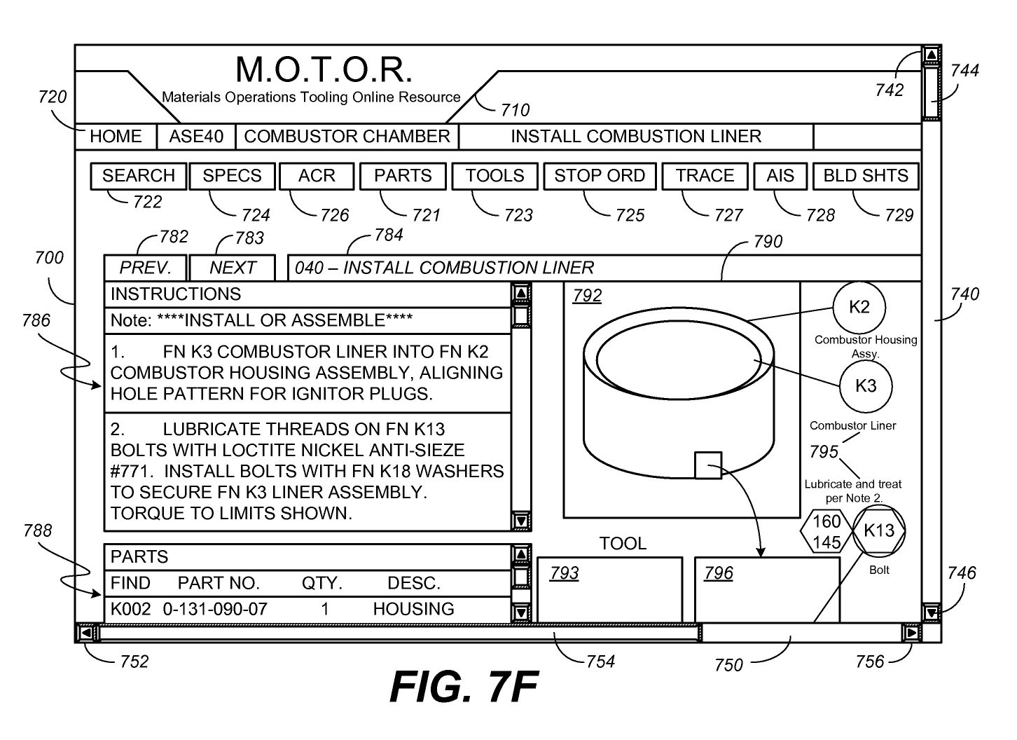

FIGS. 7A-7F are schematic diagrams illustrating various graphical-user interfaces generated for presentation via remote interface 300 of FIG. 3. It should be understood that each graphical-user interface can be arranged or constructed to present more or less information as well as provide additional navigational indicators to an operator of remote interface 300. For example, various pushbuttons present in the illustrated embodiments of FIGS. 7A-7F can alternatively be arranged in a menu panel with each item in the menu panel being selectable and operable to open a respective graphical-user interface. Furthermore, additional interfaces can be added or interfaces removed as may be desired. For example, an initial or introductory interface can be added to guide operators to a desired hierarchical level or operational level within the interface. Such an introductory interface can direct an operator to engines or sub-assemblies. Moreover, such an interface can permit operators to communicate their desire to “build” or edit a record or “browse” or review a previously entered record. The “build” mode prompts the operator to enter a specific serial number (e.g., an engine serial number or a sub-assembly serial number) and provides operator interfaces for entering data as-needed for buildsheets, operation signoff (AIS), and traceability. The “Browse” mode provides the operator with read only access.

When an operator indicates that a “build” of an engine is desired, the interface responds with an engine serial number panel. The engine serial number panel includes series or engine type, serial number, and bill of material links. An operator can open a bill of material for a specific engine by placing a cursor over the bill of material icon in the panel and entering a select input control. Similarly, an operator can open an “assemblies” panel by placing a cursor over the desired serial number and entering a select input control.

The “assemblies” panel includes respective fields for an assembly name, an assembly identifier, a quality assurance signoff, an electronic buildsheet, an electronic AIS and an electronic trace record.

The electronic buildsheet is a composite record of various information concerning an identified assembly. An example buildsheet includes fields for an engine identifier, a technician identifier, build date, inspector, location, assembly identifier, assembly description, shipping weight, shipping destination, etc. The electronic buildsheet includes sections for each operation. Each section is labeled with an operation identifier and operation title. Pertinent measurements are labeled and where applicable a tolerance range is listed. When an operator has entered a measured value that is outside a specified tolerance range or results in a calculation that falls outside a specified tolerance range, the buildsheet highlights the recorded value and the calculated result and inserts a warning statement that describes the nature of the problem.

The electronic trace record is a composite record of various information concerning the parts and sub-assemblies used to construct the identified assembly. An example trace record includes part identifiers, serial numbers and in some cases source and production information.

The quality assurance signoff panel includes one or more check boxes for one or more of a technician, a quality assurance inspector, and a production manager. One or more of the technician, inspector and manager can indicate their acknowledgement that a particular task has been correctly completed by placing a cursor over the respective checkbox and entering a select input control.

The electronic AIS is a composite record of each of the build operations, the date the operation was completed, the technician or technicians that performed the various operations, the quality assurance inspector who checked the work and the date the quality assurance check was performed.

Each of the illustrated embodiments includes a number of common elements or features that appear and in some cases are operable across the embodiments. For example, interface 700 includes information area 710, navigation bar 720, as well as search pushbutton 722, specifications pushbutton 724 and assembly change request (ACR) pushbutton 726. Information area 710 includes a title. In the example embodiments, interface 700 is titled, “Materials Operations Tooling Online Resource.” Navigation bar 720 provides a series of labels from left to right across the graphical-user interface 700 that identify a present page or frame (e.g., a home page or frame) and in other situations, the present page or frame in the furthest rightward position with previously viewed pages or frames listed in sequential order from right to left. Thus, the navigation bar 720 provides a visual reference to the operator that identifies the present page and the relative location of the present page with respect to the home page and intervening pages across the graphical-user interfaces.

When selected, search pushbutton 722 activates a pull-down menu that presents selectable menu options to search part and tool data store entries. When selected, specifications pushbutton 724 activates a specifications table that includes a list of available specifications with corresponding filenames and links to the respective files. When selected, assembly change request pushbutton 726 activates a change request table that includes a list of entered change requests with links to view the original document, as well as identifying information and status information for each respective change request.

Vertical navigation bar 740 includes pushbutton 742, slider 744 and pushbutton 746. When selected, pushbutton 742 presents that information from the uppermost portion of the interface that fits within the available frame on the presentation device. When selected, pushbutton 746 presents that information that fits within the available frame on the presentation device while showing the bottom or end of the interface. Slider 744 can be controllably positioned along vertical navigation bar 740 to controllably scroll or pan the entire interface in a vertical direction.

Horizontal navigation bar 750 includes pushbutton 752, slider 754 and pushbutton 756. When selected, pushbutton 752 presents that information from the leftmost portion of the interface that fits across the interface in the available frame on the presentation device. When selected, pushbutton 756 presents that information that fits within the available frame on the presentation device while showing the rightmost information of the interface. Slider 756 can be controllably positioned along horizontal navigation bar 750 to controllably scroll or pan the entire interface in a horizontal direction.

A feature unique to the embodiment illustrated in FIG. 7A is table 730 titled, “Engine Series.” Table 730 includes header 735 and field 737. Header 735 includes a set of information titles. Each information title is associated with a respective column of information. For example, “series” is associated with engine assemblies stored in data store 200. Table 730 further includes columns titled, “description” and “production bill-of-materials” (B.O.M.). Field 737 presents records and links to respective files that include the production B.O.M. information associated with each engine series and an assemblies page (not shown). When selected, a particular B.O.M. link directs the browser logic 326 operable on remote interface 300 to retrieve and display a select B.O.M. document from data store 200 identified by the link. When selected, an assembly link directs browser logic 326 to retrieve and present assembly information from data store 200. An assembly page (not shown) presents “parts,” “tools,” “stop order,” and “trace” menu options, as well as a table that includes selectable links to retrieve and present sub-assembly information from data store 200.

FIG. 7B illustrates graphical-user interface 700 after an operator of remote interface 300 has selected the parts menu option available via search pushbutton 722. Data entry field 760 accepts alphanumeric information entered by an operator of remote interface 300. Pushbutton 762 directs application software operable on remote interface 300, management interface 400 or other communicatively coupled computing devices to access data locations in data store 200 that match the entered alphanumeric information. Pushbutton 764 directs browser logic 326 to return to the home page.

FIG. 7C illustrates graphical-user interface 700 after an operator of remote interface 300 has selected the tools menu option available via search pushbutton 722. Data entry field 760 accepts alphanumeric information entered by an operator of remote interface 300. Pushbutton 762 directs application software operable on remote interface 300, management interface 400 or other communicatively coupled computing devices to access data locations in data store 200 that match the entered alphanumeric information. Pushbutton 764 directs browser logic 326 to return to the home page.

FIG. 7D shows graphical-user interface 700 after an operator of remote interface 300 has selected the specifications pushbutton 724. As shown, graphical-user interface responds by directing application software operable on remote interface 300, management interface 400 or other communicatively coupled computing devices to access data locations in data store 200 that contain previously stored manufacturing specifications. Browser logic 326 responds by presenting table 770 which includes title bar 775 and record field 777. Title bar 775 includes titles for filename, specification name, and portable document format. Record field 777 includes specification data with a link, specification name and a filename appearing from left to right across table 770. Pushbutton 764 directs browser logic 326 to return to the home page.

FIG. 7E depicts graphical-user interface 700 after an operator of remote interface 300 has selected an assembly tools report by selecting a link to assembly “ASE40” available in record field 737 (FIG. 7A) and the “Tools” menu option from the ASE40 assembly page. Graphical-user interface 700 responds by directing application software operable on remote interface 300, management interface 400 or other communicatively coupled computing devices to access data locations in data store 200 that contain previously stored tool information referenced in the manufacturing instructions for the ASE40 assembly. As shown, browser logic 326 responds by presenting table 780 which includes title bar 785 and record field 787. Title bar 785 includes titles for series, sub-assembly, operation, tool number, description, etc. Record field 787 includes data that reflects each of the sub-assemblies, operations, tools and a respective description. Pushbutton 764 directs browser logic 326 to return to the ASE40 assembly page. Indicator 782, when selected, directs browser logic 326 to arrange the information in table 780 in a portable document format file. Indicator 784, when selected, directs browser logic 326 to arrange the information in table 780 in a Microsoft Excel worksheet format file. Each of the features associated with portable document format files and Microsoft Excel worksheet format files are then exposed to an operator (e.g., a technician, inspector, manager) of one of remote interface 300 and management interface 400.

FIG. 7F depicts graphical-user interface 700 after an operator of remote interface 300 has selected a link to operation “040—Install Combustion Liner” available in record field 787 (FIG. 7E) from the Tools Report page. Graphical-user interface 700 responds by directing application software operable on remote interface 300, management interface 400 or other communicatively coupled computing devices to access data locations in data store 200 that contain previously stored instructions, parts, tools, image, and annotation information referenced in manufacturing operation 040. As shown, browser logic 326 responds by presenting window 790 and a host of interactive pushbuttons, tabs and navigation items.

Interactive pushbuttons include pushbutton 721, pushbutton 723, pushbutton 725, pushbutton 727, pushbutton 728, and pushbutton 729. Pushbutton 721, when selected, directs browser 326 to open a pull-down menu with engine, assembly, and operation menu items. Pushbutton 723, when selected, directs browser 326 to open a pull-down menu with engine, assembly, and operation menu items. Pushbutton 725, when selected, directs browser 326 to search data store 200 for and present any stop orders associated with the sub-assemblies and parts needed to complete operation 040. Pushbutton 727, when selected, directs browser 326 to search data store 200 for and present the trace record or file associated with operation 040. Pushbutton 728, when selected, directs browser logic 326 to search data store 200 for and present the AIS associated with operation 040. Pushbutton 729, when selected, directs browser logic 326 to search data store 200 for and present the build sheet associated with operation 040.

Window 790 includes instruction panel 786, part information panel 788, image information panel 792, tool insert 793 and detail panel 796. Instruction panel 786 includes a series of tasks that need to be completed by a technician assigned to perform operation 040. Instruction panel 786 includes a vertical navigation bar to controllably scroll through tasks that may not be presented in instruction panel 786 due to size limitations on a display device. Part information panel 788 includes a tabular list of parts that will be used to complete operation 040. Part information panel 788 also includes a vertical navigation bar to controllably scroll through part information that may not be presented in part information panel 788 due to size limitations on a display device. Image information panel 792 displays a photograph, detail drawing, or video showing the relationships between sub-assemblies and/or sub-assemblies and parts related to a particular task. Window 790 further includes annotation information 795 that includes part/sub-assembly find numbers, names, and notes. In the illustrated embodiment, annotation information 795 further includes details regarding fasteners such as a find number and acceptable range of torque to apply when completing the operation. In alternative embodiments, window 790 may include interactive controls to play an audio file and or a video file stored in data store 200 that provides further instruction regarding a task required to complete the operation. Tool insert 793 includes information identifying one or more tools that may be required to complete operation 040. Detail panel 796 includes a larger image of a select portion of the image information presented in image information panel 792.

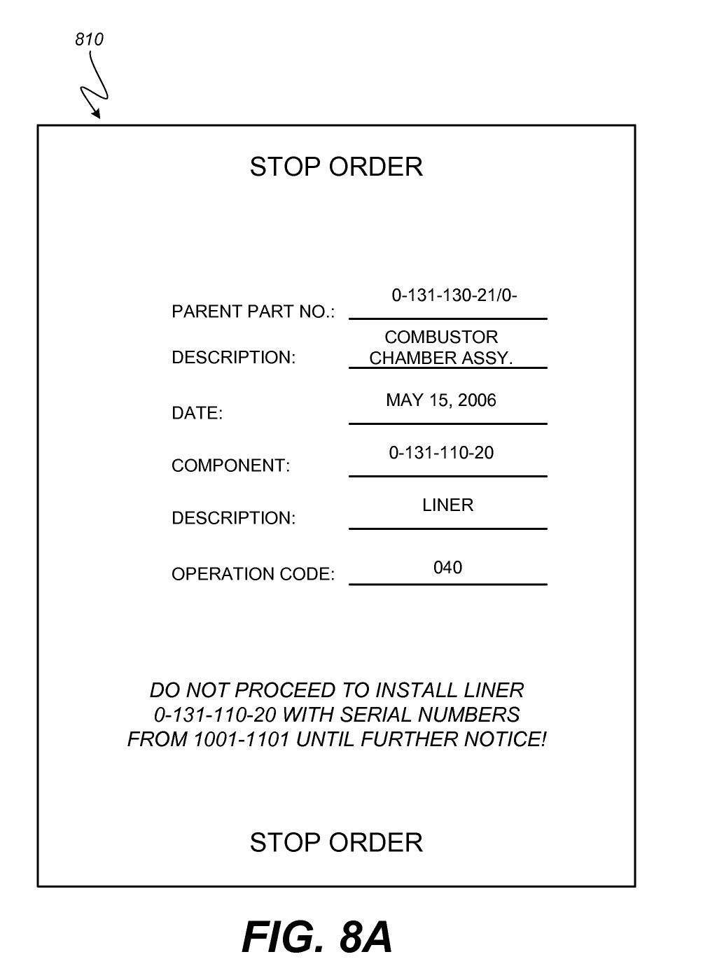

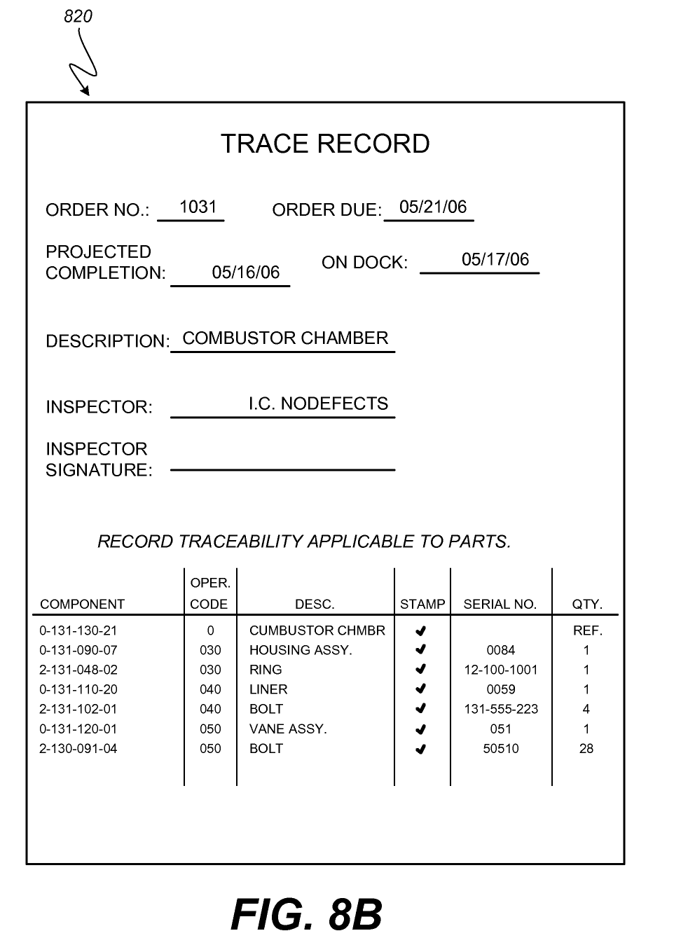

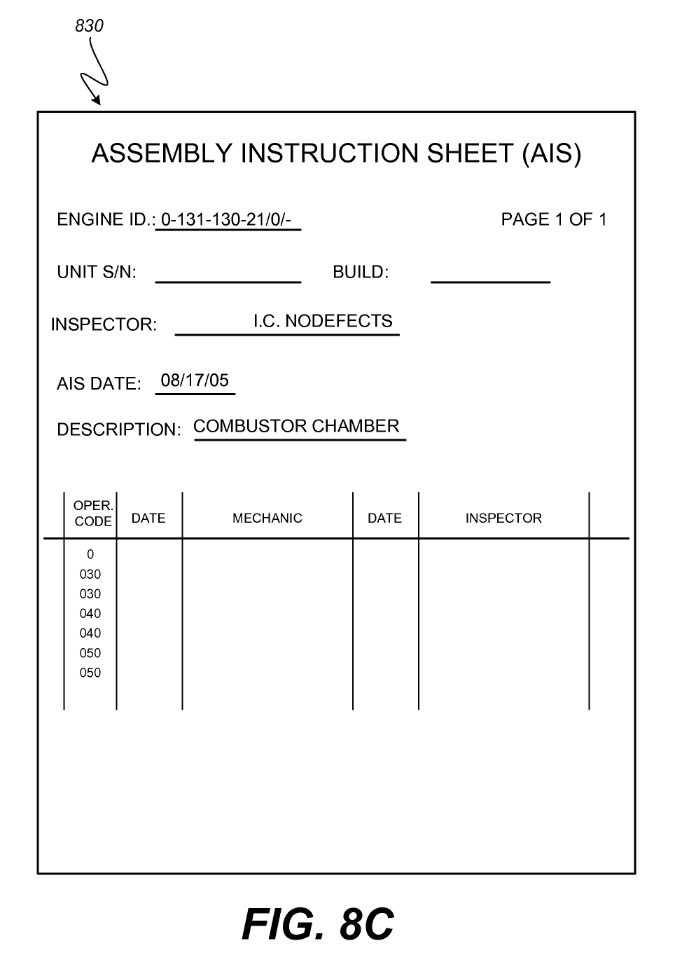

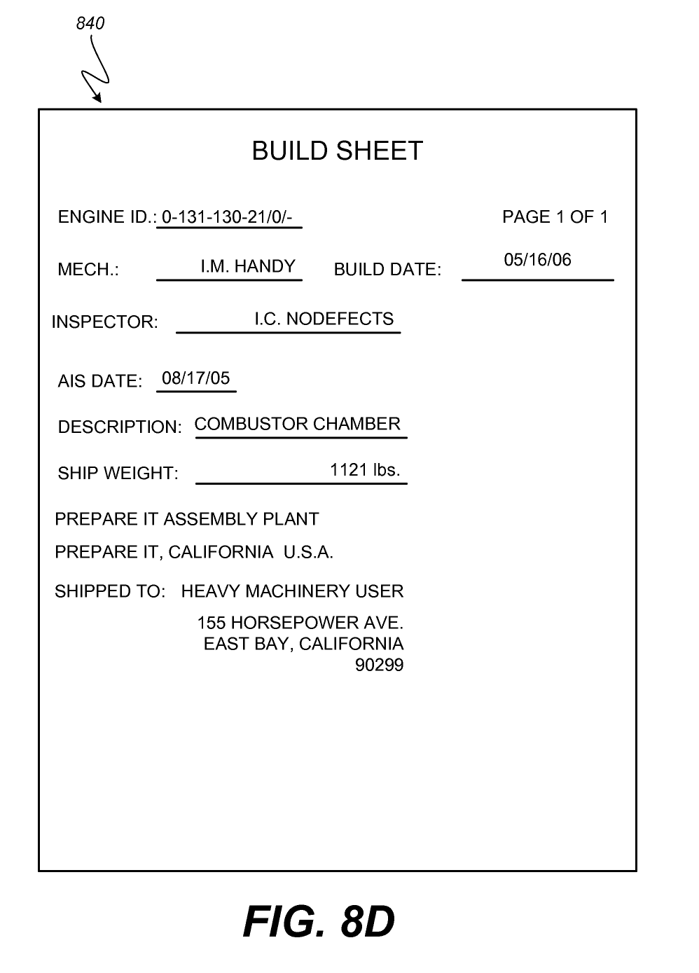

FIGS. 8A-8D are schematic diagrams illustrating example embodiments of quality assurance documents. The example embodiments illustrate a set of quality assurance documents that may be partially completed by an automated process configured to extract pertinent information from data store 200 to populate designated information in the documents. Other manufacturing and inspection specific information is entered into specific instances of each of the quality assurance documents as various operations are performed and the assembly or sub-assemblies are inspected. FIG. 8A illustrates an example stop order 810 that directs local technicians not to proceed with the installation of liner 0-131-110-20 having serial numbers from 1001-1101 into combustor chamber assembly 0-131-130-21/0 until further notice is provided. Stop order 810 further includes a stop date and an affected operation identifier. FIG. 8B illustrates an example trace record 820, which provides order, completion, inspection information, as well as a table indicating the component parts, part identifiers, operations codes, inspection completed information, etc. recorded during the assembly of the combustor chamber. FIG. 8C shows an example AIS 830, which provides identifying information associated with the combustor chamber, as well as a table indicating operation codes, dates completed (by a mechanic) and inspected (by an inspector). FIG. 8D illustrates an example build sheet 840, which provides information regarding an example assembly, such as identifiers, mechanic(s), inspector(s), build date, ship weight, manufacturer, location, shipping address, etc.

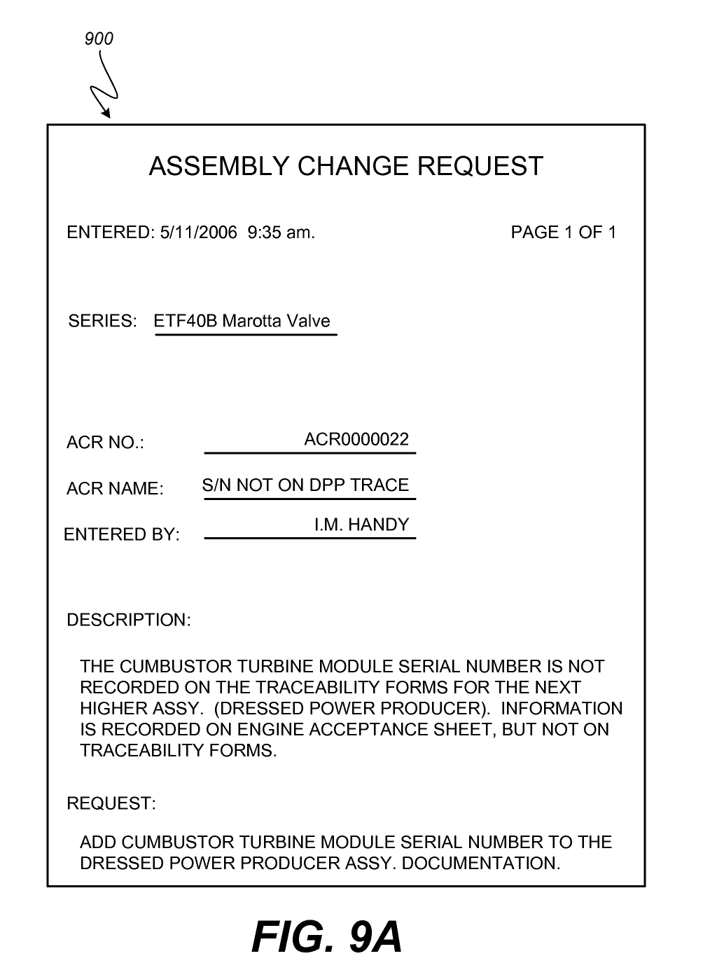

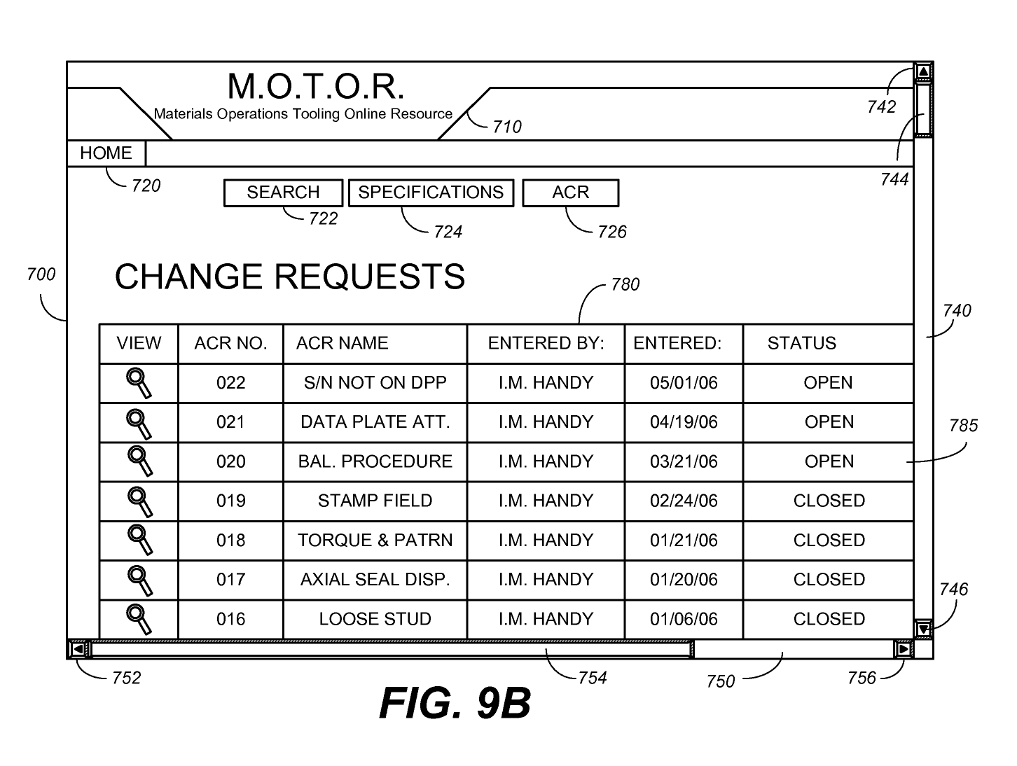

FIGS. 9A and 9B are schematic diagrams illustrating example embodiments of a change request form and a summary report of change-request information, respectively. The example change-request form 900 includes information that identifies a perceived need for a change to the manufacturing instructions, underlying data store and/or reporting logic. The example change-request form 900 includes identifying information such as the date and time the change request was entered, the name of the affected assembly, a change-request number and title, as well as the name of the requester, a brief description of a situation and the requested change.

FIG. 9B illustrates an example change request report which is presented via remote interface device 300 to one or more interested users. The example change request report is in the form of a graphical-user interface 700 operable in connection with a hypertext mark-up language compatible program commonly referred to as a browser. Graphical-user interface 700 includes title information area 710, navigation bar 720, vertical navigation bar 740, horizontal navigation bar 750, as well as search pushbutton 722, specifications pushbutton 724 and assembly change request pushbutton 726. Title information area 710 includes one or more labels identifying the present subject matter viewable within graphical-user interface 700. Navigation bar 720 provides a series of labels from left to right across the graphical-user interface 700 that identify a present page or frame (e.g., a home page or frame) and in other situations, the present page or frame in the furthest rightward position with previously viewed pages or frames listed in sequential order from right to left. Navigation bar 740, pushbutton 742, slider 744 and pushbutton 746 enable interactive vertical navigation over the interface information as described above in association with FIGS. 7A-7F. Similarly, navigation bar 750, pushbutton 752, slider 754 and pushbutton 756 enable interactive horizontal navigation across the interface information as also described above in association with FIGS. 7A-7F.

The foregoing has been presented for purposes of illustration and description. It is not intended to be exhaustive or to limit the scope of the claims to the precise forms disclosed. Modifications or variations are possible in light of the above teachings. The embodiments discussed, however, were chosen and described to enable one of ordinary skill to utilize various embodiments of the systems and methods for managing a remote production facility. All such modifications and variations are within the scope of the appended claims when interpreted in accordance with the breadth to which they are fairly and legally entitled.

What is claimed is:

1. A method for managing a remote production facility, comprising:
providing instructions for manufacturing assemblies and sub-assemblies;
providing information responsive to parts, tools and operations referenced in the instructions for manufacturing each of the assemblies and sub-assemblies;
providing a set of quality assurance documents referenced in the instructions for manufacturing each of the assemblies and sub-assemblies; and
controllably granting access to a network coupled interface that exposes the instructions, information related to the parts, tools and quality assurance documents.

2. The method of claim 1, wherein providing instructions for manufacturing comprises storing information that directs a user of the network accessible interface to complete steps in manufacturing an engine.

3. The method of claim 2, wherein providing instructions for manufacturing comprises storing a bill-of-materials used in manufacturing the engine.

4. The method of claim 2, wherein providing instructions for manufacturing comprises storing both annotation and image information.

5. The method of claim 1, wherein providing instructions for manufacturing comprises storing information that directs a user of the network accessible interface to complete steps in manufacturing a modular component used in manufacturing an engine.

6. The method of claim 5, wherein providing instructions for manufacturing comprises storing both annotation and image information.

7. The method of claim 1, wherein providing information related to parts, tools and operations referenced in the instructions comprises hierarchically associating the information.

8. The method of claim 1, further comprising:
providing a report responsive to a user input indicative of one of assembly parts and tools or sub-assembly parts and tools.

9. The method of claim 1, further comprising:
providing a report responsive to a user input indicative of an operation.

10. The method of claim 1, wherein providing a set of quality assurance documents comprises providing one of an assembly instruction sheet, a stop order, a traceability record and a build sheet.

11. The method of claim 1, further comprising:
providing a user form for communicating a change request.

12. A system for guiding technicians through manufacturing tasks, comprising:
a network;
a data store coupled to the network, the data store comprising information associated hierarchically, the information including at least a bill-of-materials, manufacturing instructions, partially completed quality assurance documents, part identifiers and parameters, tool identifiers and parameters;
a first interface located at a manufacturing site and communicatively coupled to the data store via the network; and
a processor coupled to the data store and the interface via the network, the processor configured to enable a user of the interface to controllably access the data store.

13. The system of claim 12, wherein the network comprises one of a local-area network, a publicly accessible wide-area network, a virtual private network, and a proprietary network.

14. The system of claim 12, wherein the partially completed quality assurance documents comprise an assembly instruction sheet, a stop order, a traceability record and a build sheet.

15. The system of claim 12, wherein the data store further comprises annotation and image information.

16. The system of claim 12, wherein the data store further comprises a user form for communicating a change request.

17. The system of claim 12, wherein the processor is configured to provide limited access to the data store via the first interface.

18. The system of claim 12, further comprising:
a management interface coupled to the data store via the network, wherein the processor is configured to provide edit privileges to an operator of the management interface.

19. The system of claim 18, wherein the operator of the management interface is permitted to modify information responsive to a change request.

20. The system of claim 18, wherein the operator of the management interface is permitted to modify one or more of assembly, sub-assembly, part, tool, operation, and partially completed quality assurance document information.
